(19) United States
(12) Patent Application Publication
(10) Pub. No.: US 2008/0113556 A1
(43) Pub. Date: May 15, 2008

(54) Lockable and Sealable Connector

(76) Inventor: Michel Ritter, Echichens (CH)

Correspondence Address: NIXON & VANDERHYE, PC, 901 NORTH GLEBE ROAD, 11TH FLOOR, ARLINGTON, VA, 22203, US

(21) Appl. No.: 11/794,332

(22) PCT Filed: Jan. 9, 2006
(86) PCT No.: PCT/IB06/50076

§ 371 Date: Jul. 24, 2007

(30) Foreign Application Priority Data
Jan. 13, 2005 (CH) 00044/05
Jan. 13, 2005 (CH) 00045/05

(51) Int. Cl. H01R 13/648

(52) U.S. Cl. 439/607

(57) ABSTRACT

The plug (10) comprises first (10′) and second (10″) portions, wherein said second portion is arrangeable in the cylindrical cavity of a socket, a sleeve (12) consisting of first (12′) and second (12″) parts and an abutment element (11) for blocking the sleeve (12) displacement in the cylindrical cavity direction. Said abutment element (11) and the plug (10) are embodied in one piece and said second part (12″) of the sleeve is selected such that it is flexible in order to enable the sleeve (12) to be displaceable over the abutment element (11).

### FIELD OF THE INVENTION

The present invention relates to the field of sealed, lockable connectors of the “push-pull” type.

Such connectors are known in the prior art, for example from publications EP 1 577 985, U.S. Pat. No. 6,290,525 B1 and EP 0 875 959. In the connector described in EP 1 577 985, a particular mechanism makes it possible to lock the two parts of the connector together and therefore prevent an inadvertent disconnection if the cable is pulled. Accordingly, this publication is incorporated by reference into the present application with respect to the elements used for the operation of a locking system.

More particularly, this type of connector is characterized by a series of elastic strips fixedly attached to the end of a movable sleeve that covers the body of one of the two connector elements. Once the connector is closed, the strips are housed between the body of the element that they surround and the external part of the second connector element. The end of the body comprises a conical ramp designed to act on the ends of the strips to cause them to spread apart when axial forces act on the male and female part of the connector to separate them, thereby preventing this separation.

A disadvantage resulting from the principles currently used lies in the fact that the strips are greatly acted upon when lateral forces are exerted on the connector, for example during pulls or oscillations applied to the cable. Because of the space made beneath the strips to allow them to bend back during unlocking, the strips progressively sustain a crushing action which may promote an accidental unlocking of the connector.

One solution for remedying this problem consists in reducing the length of the slots situated between the strips or, alternatively, in increasing the width of the strips, in order to make the latter more rigid, hence more resistant to the crushing actions. This approach is however unsatisfactory because it then makes the disconnection of the connector more difficult.

FIG. 1 represents, as an example, a connector of the “push-pull” type combining both a locking mechanism and a seal against fluids. This type of design has been used for a long time in many applications as indicated above.

More particularly, in FIG. 1, that illustrates a connector of the prior art as indicated above, there are mainly three elements that will be useful for understanding the invention. Naturally, for a more detailed description of this type of connector, reference may be made to the publications of the prior art indicated at the beginning of the present description. Thus, the connector comprises in particular in zone 1, that is that of the cable 6, a tubular body 1 forming, with a locking sleeve 2 that can be moved axially on the body 1, the male part 5, and serves to perform the locking action. At the end of the body 1, there is a tubular casing 3 that is attached to said body in the manners indicated below, the whole assembly belonging to the male part 5. On the right of FIG. 1, in zone 2, there is the female part 4 of the connector into which the male part 5 is inserted.

The need to be able to adapt these connectors to cables with varying dimensions means that the rear zone of the connector (zone 1) is most frequently substantially larger in diameter than the interconnection part (zone 2) which frequently must, on the other hand, be small for imperatives of space requirement of the connector base usually situated on a device.

From these geometric considerations it follows that the mounting of the components is conventionally and necessarily carried out in the sequence represented in FIG. 2 from which follows a necessary sealing of the tubular casing 3.

Sealing is an operation that is usually costly and may, depending on the chosen method, require a test to verify the seal.

FIG. 2 illustrates the sequence A and B for mounting the three elements 1 to 3 identified above and belonging to the male part 5. Because of the diameter, dimension, size constraints, it is understood that first of all the locking sleeve 2 is inserted onto the body 1, said sleeve comprising a locking part 2a (for example strips) whose diameter must be smaller than the diameter of the tubular casing 3 in order to ensure that the locking mechanism operates, according to the known principles for such connectors of the “push-pull” type (see the publications mentioned above). The tubular casing 3 is therefore fitted last in the mounting sequence and it serves to spread apart the strips of the locking part 2a of the sleeve 2 as is known in the prior art. Consequently, the join of the tubular casing 3 on the body 1 must be sealed, which may be done by various means, for example with seals, or with the aid of adhesives or else via a welding process or else by mechanical deformation, or even driving.

In addition to the complication and added cost generated by this additional operation for mounting the tubular casing 3, another disadvantage is the fact that, once mounted, the device can no longer be removed without separating the tubular casing 3 from the body 1 which may cause damage and even the destruction of the pieces 1 and/or 3.

A solution to this problem has been described in patent U.S. Pat. No. 6,290,525. In the connector described in this patent, on the one hand a tubular casing with a plurality of “bosses” is provided and, on the other hand, slots are left between the strips of the sleeve at least as wide as the width of the bosses of the tubular casing. Therefore, it is possible to insert the tubular casing into the sleeve via the proximal end by causing the bosses to enter the corresponding slots between the strips, then a relative rotation of the two pieces is carried out so that the strips are in line with the bosses and the locking mechanism operates.

It is easy to understand that this system is not optimal in that it is necessary to manufacture a particular tubular casing with bosses; during mounting, it is necessary again to carry out a relative rotation of the two pieces so that the locking mechanism operates, this particular position having to be maintained by additional means when the connector is operating. In other words, this complicates the manufacture of the pieces and the mounting procedure and one runs the risk that the locked state is not held.

By convention, in the present application, the word “plug” will designate the male part of the connector and the word “socket” the female part of the connector.

### SUMMARY OF THE INVENTION

One objective of the invention is to remedy the problem of cost by removing the need to seal parts, and hence to test them.

Another objective of the invention is to improve the known connectors.

More particularly, one object of the invention is to propose a connector that is effective and easy to produce without substantially increasing the cost.

Another object of the invention is to propose a connector system that is easy to use and that retains the locking and sealing properties of the connector.

These objects are achieved by the connector defined in the claims.

The invention will be better understood through the description of the embodiments of the latter given as nonlimiting illustrative examples and the figures relating thereto.

### BRIEF DESCRIPTION OF THE FIGURES

FIG. 1 illustrates in section an example of a “push-pull” connector of the prior art.

FIG. 2 illustrates side views of the mounting sequence (sequence A and B) of the plug of a connector similar to that of FIG. 1.

FIG. 3 illustrates side views in section of the mounting sequence of the plug of a connector according to the invention.

FIG. 4 illustrates a second embodiment of the connector.

FIG. 5 illustrates a third embodiment of the connector.

### DETAILED DESCRIPTION OF THE INVENTION

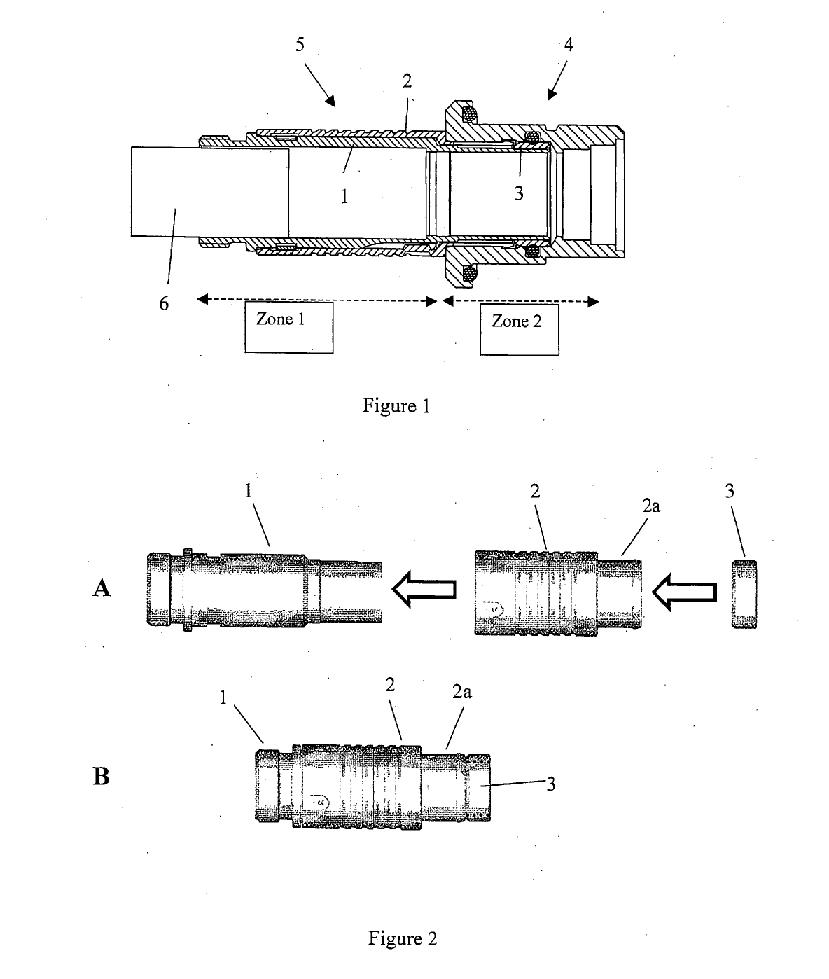

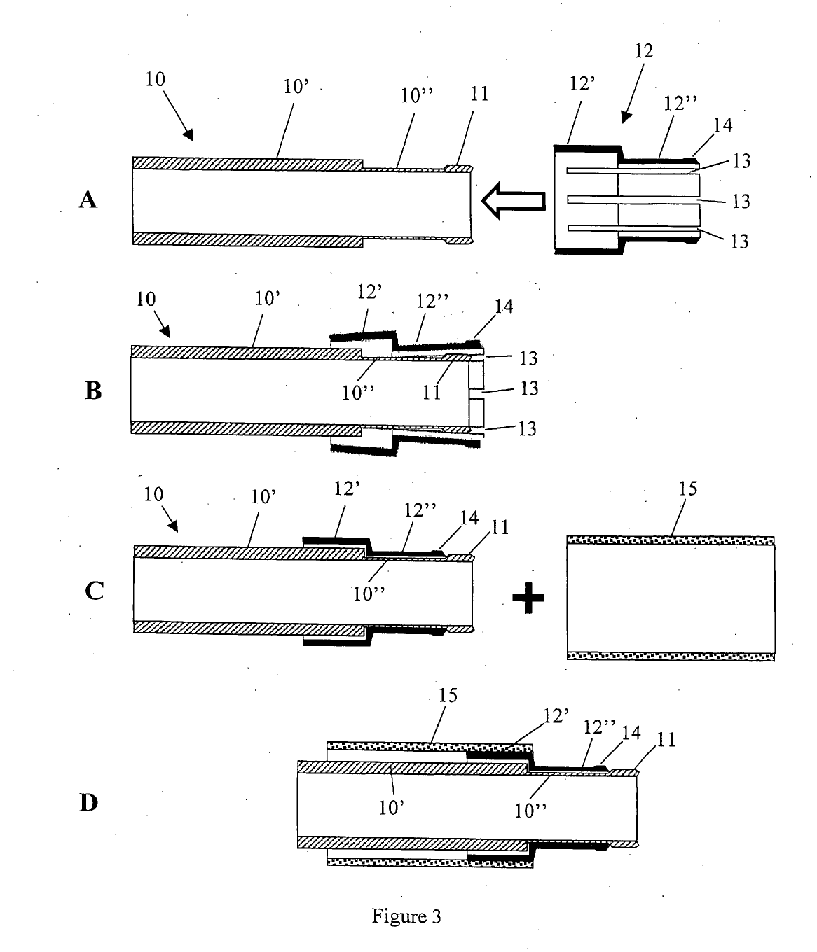

According to the invention and as shown in the sequences A to D of FIG. 3, the body 10 forming the plug comprises a first cylindrical portion 10′ and a second cylindrical portion 10″. It also comprises at its end a profile 11 exactly matching the shape of the tubular casing 3 previously used (see FIGS. 1 and 2). The tubular casing 3 is therefore no longer required here since it is replaced by the profile 11 that forms part of the body 10.

The sleeve 12, for its part, comprises a first part 12′ designed to surround the first part 10′ of the body 10 and a second part 12″, designed to surround the second part 10″ of the body 10, comprising strips separated by slots 13 and performing the locking function as described above.

In order to be able to mount the locking sleeve 12 despite the presence of the profile 11, it is made diametrically elastic, for example by lengthening the slots 13 or increasing their number, so it can be assembled onto the body 10 by deforming diametrically when it passes over the profile 11, as illustrated schematically in FIG. 3, sequence B.

The end of the sleeve 12 comprises bosses 14 on the strips forming the part 12″ that make it possible to perform the function of locking the mounted connector, in a manner known in the prior art.

After the sleeve 12 has been installed (see FIG. 3, sequence C), an additional, optional piece 15 makes it possible on the one hand to stiffen the sleeve 12 and to perform all the technical and ergonomic functions of the conventional sleeve 2 described above particularly for the unlocking of the connector.

The piece 15 may or may not be required and its features dictated amongst other things by the choice of the materials forming in particular the sleeve 12. Once assembled (see FIG. 3, sequence D) the plug has the same features as its conventional version of FIG. 1.

As indicated above, the sleeve 12 is made diametrically elastic to allow it to be mounted, this elasticity being obtained either by lengthening the slots 13 for example over the major part of the axial length of the sleeve 12, or else by increasing the number of slots, or else by combining these two procedures.

According to one variant, it is possible to extend one of the slots 13 over the whole length of the sleeve 12. In this case, the additional piece 15 is necessary to “close” the sleeve 12 and prevent it from separating from the plug 10.

Since the tubular casing according to the invention does not have the principle of the bosses as taught in patent U.S. Pat. No. 6,290,525, all their disadvantages are avoided: more complicated manufacture, particular mounting, reduced number of locking strips, etc. This known tubular casing does not make it possible to ensure the seal because this part is cut, consequently is not leaktight on a seal placed as indicated in FIG. 1 of the present application.

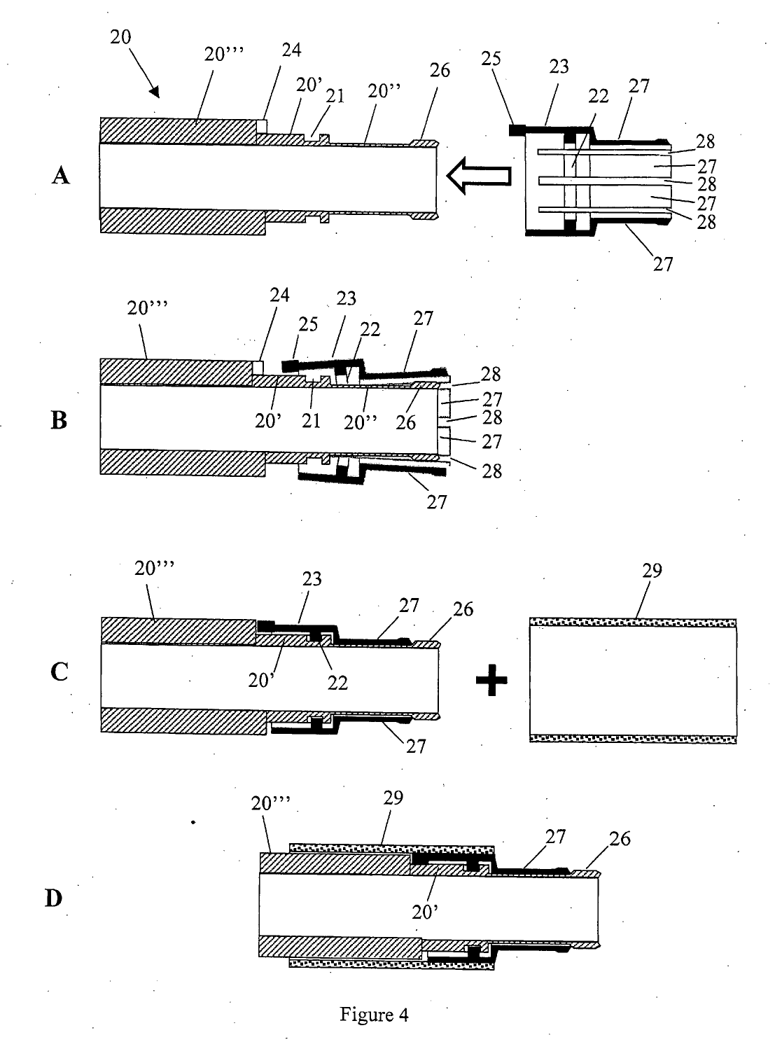

According to another embodiment of the invention, represented in FIG. 4 by the mounting sequence A to D, means are provided for limiting the travel of the sleeve relative to the plug. The plug 20 comprises a first cylindrical portion 20′ and a second cylindrical portion 20″ of lesser diameter. The part 20′ comprises an annular groove 21 extending over the periphery of the plug in which an annular element 22 of the sleeve 23 is designed to nest to limit the travel of the sleeve 23 in the axial direction. The first portion 20′ also comprises an axial notch 24 that extends in the body 20′″ of the plug 20. The sleeve also comprises an axial extension 25 of a shape matching the notch 24 which, once the sleeve 23 is mounted on the plug 20, makes it possible to prevent a relative rotation of these two elements. It is therefore possible to easily orient the plug 20 relative to the socket 4 (see FIG. 1) in order to align the contacts at the moment of connection by rotating the sleeve.

It should be noted that the groove 21 and the annular element 22 may be inverted. Similarly, it is also possible to invert the notch 24 and the extension 25.

In this embodiment, it may be useful to add an additional piece 29 similar to the piece 15 of the first embodiment described above and for the same reasons, particularly stiffening the sleeve 23, or if one of the slots 28 extends over the whole length of the sleeve 23.

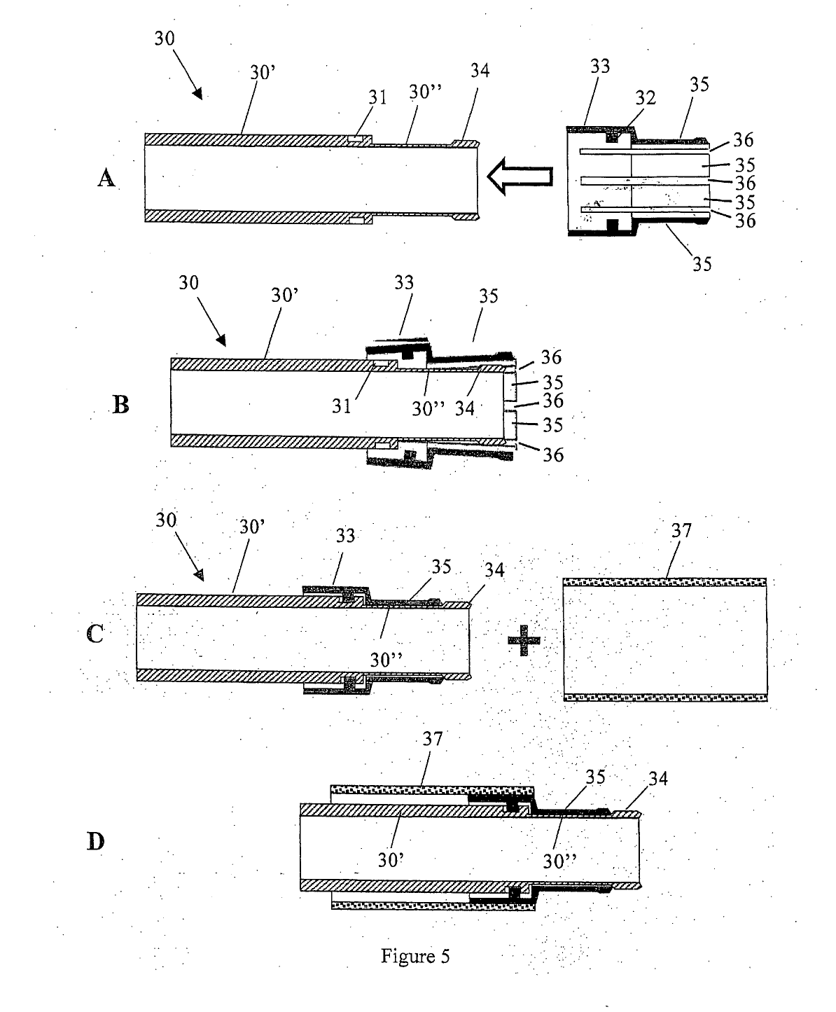

FIG. 5 shows the mounting sequence A to D of another embodiment of the invention. In this embodiment, the plug 30 comprises a first portion 30′ and a second portion 30″ of reduced diameter. The first portion also comprises at least one cavity 31 (two cavities are shown in FIG. 5) that is designed to receive a protuberance 32 of the sleeve 33. By the use of one (or more) cavity(ies) 31 and of the corresponding protuberance(s) 32, it is possible via this single means to ensure a limitation of the axial travel of the sleeve 33 and provide a rotational lock. It is therefore possible to dispense with the notch 24 and with the extension 25 of the embodiment described above in relation to FIG. 4.

The mounting sequence A, B and C of FIG. 5 applies the same principles as the corresponding sequence of FIG. 3.

Once the sleeve 33 is correctly mounted and the protuberance(s) 32 is/are in their cavity 31 (see FIG. 5, sequence C), it is possible to add an additional piece 37 identical to the piece 29 of the preceding embodiment or 15 of the first embodiment. This optional piece makes it easier to move the sleeve 33 on the plug 30 and to stiffen the sleeve 33.

The mounted state is shown schematically in the sequence D of FIG. 5.

According to a variant, applicable to all the embodiments described above, it is also possible to extend only one of the slots 13/28/36 over the whole length of the sleeve 12/23/33 to make its mounting still easier. In this case, it is necessary to use a supplementary means to ensure the closure of the sleeve once mounted, for example adhesive, or else by means of the additional piece 15/29/37 which is slid over the sleeve 12/23/33.

The materials used for the sleeve 12/23/33, and for the additional piece 15/29/37, may be metal or plastic or else other materials such as composites etc. The additional piece may be driven onto the sleeve or bonded or attached by another equivalent means.

The advantages of the invention are as follows:
No sealing of the tubular casing 11=reduction of costs
Fusion of the pieces 10 and 11 into a single piece=seal ensured and independent of the mounting process
Increased flexibility in the choice of the materials and the shapes of the pieces; esthetic, ergonomic and functional advantages.

1-13. (canceled)

14. A plug (10) for a connector of the push-pull type comprising:
a first cylindrical portion (10′) and a second cylindrical portion (10″) of lesser diameter than the first portion, the second portion being designed to be housed in a cylindrical cavity of a socket,
a locking/unlocking sleeve (12) adapted to move around the plug and having a first part (12′) designed to surround said first portion (10′) and a second part (12″) designed to surround said second portion (10″),
an abutment element (11), of annular shape, placed around the free end of said second portion (10″), said abutment element (11) being suitable for blocking the movement of the sleeve (12) in the direction of the cylindrical cavity,
wherein
the abutment element (11) and the plug (10) form a single piece,
the second part (12″) of the sleeve is made elastic so as to allow its movement over the abutment element (11) prior to the insertion of the plug in the socket.

15. The plug as claimed in claim 14, wherein the second part (12″) of the sleeve (12) is made elastic by a series of longitudinal slots (13).

16. The plug as claimed in claim 15, wherein said slots (13) extend over the greatest part of the axial length of the sleeve (12).

17. The plug as claimed in claim 14, comprising an additional stiffening piece (15) attached to the sleeve (12).

18. The plug as claimed in claim 14, wherein the sleeve comprises a slot that extends over its whole length, said plug comprising an additional stiffening piece (15) attached to the sleeve (12).

19. The plug as claimed in claim 17, wherein the additional piece is driven onto the first part (12′) of the sleeve (12).

20. The plug as claimed in claim 14, wherein said plug (10) and said sleeve (12) comprise retention means (21, 22; 31, 32) interacting with one another to limit the travel of the sleeve relative to the portions of the plug.

21. The plug as claimed in claim 20, wherein said retention means are formed of an annular groove (21) on the first portion of the plug and an annular element (22) on the sleeve and designed to be housed in said groove.

22. The plug as claimed in claim 21, wherein the retention means also comprise a notch (24) extending in the axial direction of the plug and an axial extension (25) of the sleeve, said extension being designed to engage in said notch.

23. The plug as claimed in claim 22, wherein the retention means also comprise a notch extending in the axial direction of the sleeve and an axial extension of the plug, said extension being designed to engage in said notch.

24. The plug as claimed in claim 20, wherein said retention means comprise at least one cavity (31) in the plug and a protuberance (32) on the sleeve, said cavity and said protuberance having matching shapes so that they allow a limited travel in the axial direction of the sleeve relative to the portions of the plug and prevent a relative rotation of the sleeve relative to said portions.

25. The plug as claimed in claim 20, wherein said retention means comprise at least one cavity in the sleeve and a protuberance in the plug, said cavity and said protuberance having matching shapes so that they allow a limited travel in the axial direction of the sleeve relative to the portions of the plug and prevent a relative rotation of the sleeve relative to said portions.

26. An electric connector comprising a socket (4) and a plug (10, 20, 30) as defined in claim 14.
